(19) United States
(12) Patent Application Publication
(10) Pub. No.: US 2015/0019523 A1
(43) Pub. Date: Jan. 15, 2015

(54) EVENT-BASED SOCIAL NETWORKING SYSTEM AND METHOD

(71) Applicants: Adam Lior, Brookline, MA (US); Raphael Lior, Brookline, MA (US)

(72) Inventors: Adam Lior, Brookline, MA (US); Raphael Lior, Brookline, MA (US)

(21) Appl. No.: 13/942,401

(22) Filed: Jul. 15, 2013

(51) Int. Cl. G06F 17/30

(52) U.S. Cl. CPC G06F 17/30053
USPC 707/708

(57) ABSTRACT

An event-based social networking system enables users of the system to create and schedule events, extend and respond to invitations, facilitate creation of albums of media memorializing the events and enabling members of the social network community to control sharing, viewing and commenting on media contained in the albums.

### TECHNICAL FIELD

The subject matter described relates to techniques, methods, systems and mechanisms by which members of a web-based, networked community can interact and share media and related information with each other with respect to events at defined geographic locations.

### BACKGROUND

Users of mobile and other electronic communication devices commonly connect with other users through Internet-based social networks. Such users typically provide information about themselves including, for example, contact information, personal or business interests, images and the like with a view to communicating with other users having similar or related interests. The social networking systems typically include privacy applications by which users can select those other users with whom they wish to communicate as well as to limit the level of information to which other users may have access. A user of the social network, such as an individual, or other entity who agrees with other network users to communicate via the social network (e.g., those persons designated as “friends” of the user) may be considered to define that user's community. A user may be a member of more than one social network community and a user's friends may be members of other communities.

Mobile computing devices such as smart phones, tablets and laptop computers commonly include web-based location-identifying systems (e.g., global positioning systems) for displaying maps and identifying locations including the location of the mobile device itself as well as other locations and facilities. Typically, they also include photographic (still and video) and audio functions by which images and audio (collectively, “media”) can be captured, stored and transmitted over communications networks. It would be desirable to provide a web-based social networking system by which events could be organized for and by members of a social network community at specific venues and in which the members of the community could share media and interact with each other with respect to the events and media created at those venues. It also would be desirable to provide a system by which attendees at the event can record and store media and related commentary memorializing the event to be shared with each other as well as with other of their friends in their social network communities. It is among the general objects of the invention to provide such a system and methods.

### SUMMARY OF THE INVENTION

The system includes one or more server computers that may be provided by a social network provider that facilitates operation of the system. The server system communicates with a data storage system and database that retrievably stores profile and other information for the users of the social network as well as information and media relating to events that have been uploaded to the server by members of the social community. The server system communicates through a communications network, such as the Internet, with user computing devices such as mobile smart phones with a photographic function or any other computing device with the ability to capture and wirelessly transmit and receive images. The server and data storage system also can be accessed from locations remote from the events but without the ability to capture and transmit images to the server.

The system includes a social networking web application program that may reside on the server although portions of the application reside in the user devices. The application includes a media-sharing module by which users can connect via the communications network to use the social networking service to share media associated with specific events with members of the user's community. Users of the social network can connect to the server and application to control and access the features of the application by controls provided on user interfaces (UIs) displayed on the user devices. The user interfaces may be generated by the social networking application and thereafter stored in local memory in the user device.

The social networking application enables a member to create and schedule an event, post information including audiovisual media and/or textual content regarding the event, send invitations to the event to selected members of his social network community, respond to invitations of others, obtain demographic and other information about events that other members of his community plan to attend or are attending, view uploaded media and comments relating to events in which members of his social network have participated, and post comments related to the media and comments uploaded by members of his community. Audiovisual media and textual information may be uploaded with respect to an event using File Transfer Protocol (FTP) or any other system to create related information (metadata) for identification and/or description of the uploaded images and text to facilitate retrieval from a data storage system of images and text comments for a particular event and to enable them to be arranged into albums memorializing the event. Members of a community of an attendee at the event can access the album and post comments during and after the event. Audiovisual media can only be uploaded during the event and only by attendees while they are at the event.

When a user logs in to the system, the application generates and displays on the user's device a default UI that lists past and present events that involve at least one “friend” of that user's social network community and to which the user has the right to access. The user can request the server to transmit and display an album of media relating to any of those events. A user can view media and comments relating to the selected event. The default UI and application program enables the user to view, create, locate and search for such events.

An event may be created by any user of the social network by invoking an event-creation UI on the user's device that enables the user to “host” an event by entering information concerning the event such as the name of the event, its location and scheduled time, the identification of the user hosting the event, the type of event and a level of privacy to define the range of users to whom invitations may be extended. The event creation interface enables textual input for a description of the event and also enables the host to include a graphic iconic image relating to the nature or location of the event or any other image as determined by the host. The information relating to the event is transmitted via the network to the server that then compiles a list of the members of the host's social network community (“friends”) and transmits the list for display in a UI (the “invitation interface) on the hosting user's device. In order to invite friends to the event, the host selects those of his friends that he wishes to invite and transmits the list of the invitees to the server. The server, in turn, transmits to the invitees' user devices a signal that causes display of an invitation response control on the invitee's user device. The invitation response control prompts the invitee to respond to the invitation. The invitee may select a response control indicating that he will attend, will not attend or has not yet decided and his response is automatically transmitted through the communications network to the server. If the response is an acceptance of the invitation, the application causes the invitee to be added to a guest list. The guest list may be displayed as a guest list UI that may be accessed by any user who has access right to view media from an event for which a friend of the user is on the list. The guest list can be viewed in advance of the event.

The invitation also may include an indication of the level of privacy, that is, whether the invitation is only to the direct, primary invitees or whether the direct invitees can invite additional guests (“friends of friends,” also referred to as “secondary invitees”) and, if so, whether the number of additional guests that may be invited is limited. All invitees, direct and secondary, who accept an invitation, are added to the guest list.

The system application program includes a media-sharing module for controlling the ability of user devices to upload media from the event to the server and to enable community members to view and/or share that media. To that end, the system determines, at the time of the event, which of the attendees who accepted the invitation actually are present at the venue by determining the location of their user devices. At or about the time that the event is scheduled to begin the application program causes the server to query, at selected intervals, the user devices of users on the guest list to determine whether the user is at or in a defined proximity to the event venue. The query requests the user device to invoke its location identification module, for example, one that relies on a global positioning system (GPS). In response to that query the user device determines and transmits to the server the location coordinates of the user device. Those coordinates are compared to the coordinates for the venue stored in the database to determine if the user is at or in the vicinity of the venue. If a guest's user device is determined to be in the vicinity of the venue, the application program sends a signal to the user device that enables operation of the portion of the media-sharing module that resides in the guest's user device.

The media-sharing module in the user device enables photos, videos and audiovisual media captured by the attendee's device, together with metadata identifying the media, to be transmitted directly and automatically to the server. The metadata should include information about the media such as its source, event and time, sufficiently to enable the media to be grouped for presentation as an album that includes media from the attendee's device as well as from the user devices of the friends of the attendee who also are present at the event. Only attendees at the event can serve as media sources to upload event media to the server. The media-sharing module causes each source's media to be linked with each of the source's friends at the event so that a source's album will include media that he captured and uploaded as well as that of his attending friends. Non-attending members of the attendees' community on the social network may be permitted to view all media in their friends' albums and may post comments relating to that media, depending on the selected settings for the event when the event was created by the host. The media-sharing module enables an attendee to share uploaded media with all of his friends in attendance at the event, regardless of whether they were his or another user's invitees. The module enables an attendee to post comments, take photos and videos and to share them with his friends and the friend's guests in attendance. Comments on media as well as comments on comments of others may be posted by anyone who has a right to access to an album containing the media whether or not they attended the event.

Uploading of media and comments continues until the event has ended. When the time for the event has ended the application program disables the ability of the user devices to upload media content to the server. All of the media, comments and related metadata that were uploaded during the event are stored in the database. The application program enables retrieval, grouping and display, in chronological sequence, of media and comments in albums so that users having the right to access that content may do so during and after the event. An attendee's album includes the media created and uploaded by that attendee as well as all media uploaded by those of his friends on the social network who also attended the event. Media from attendees who are not in that user's social network community is not included in that user's album. Users, whether sharing attendees or non-attending friends may revisit their own or their friend's respective albums and may continue to post comments associated with specific media after the event has concluded.

Media may be deleted from the database only by the attendee who was the source of and uploaded the media. While other users can delete their links to items from their viewable media, they cannot delete those items from the database; others who have access rights to those items will continue to be able to view them.

The application program of the system may include a statistics module by which the server can determine, based on data retrieved from the database, the statistical demographics relating to those attending a current event or planning to attend a future event. The statistics module output may be presented to the user, for example, in a UI that displays information reflecting the demographics of the attendees at the location of the event. In one example, such as a primarily social event, the information may include the number and balance of men and women who will be in attendance, whether they are in a personal relationship, what they may be interested in, their age group, their level of education, nature of their occupation or other information that may reflect the demographics of the attendees. The data may be displayed as a histogram or in other graphic presentations. These functions enable users to screen certain locations or events based on statistical demographics and base a decision whether to attend based on that information. As more users accept invitations, the statistical significance increases which refines the search for users on the network. In another aspect of the invention, the statistics module may include an affinity module by which the degree of similarity between the profile information of the user and the profile information of other users who are on the guest list for an event at that location can be determined. The affinity module generates and displays for each current and future event, an affinity indicator that reflects the degree of affinity (commonality of interests or demographic characteristics or other parameters) of the user to those persons on the guest lists at a location where a particular event is or will be held, thus facilitating the user's level of interest in that event.

The system includes a search function by which a user may use the location services module in his device to view the geographic location of particular events and may search to locate events and locations. For example, a user may have traveled to or plans to travel to a location where he may have friends but is unaware of any scheduled events involving members of his community. The system enables the user to query the server for a selected date and location, using a location services system (e.g., GPS), or by manual entry. The user's device communicates the query to the server via the Internet and the server executes the application program in cooperation with the event data stored in the database to determine whether there are any venues in the vicinity of the queried location with events to which one or more of the user's friends have accepted invitations. The system determines and displays on a map UI on the user device the locations of such events. The system also may retrieve the profiles of the users who plan to attend an event at the location and the affinity module may determine the affinity of the user to those who are planning to attend. The degree of affinity for specific locations may be indicated directly on the map, for example, with variably colored markers (e.g., location pins or other indicia) displayed on the map interface.

### DESCRIPTION OF THE DRAWINGS

The foregoing and other features and advantages of the invention will be appreciated more fully from the following description, with reference to the accompanying drawings in which:

FIG. 1 is a diagram of a system architecture for practicing the invention;

FIG. 2 is a representative default graphic user interface that may be displayed on the screen of a user's computing device, such as a smart phone, upon login by the user to the social network;

FIG. 3 is a flowchart of the operation of portions of the system by which a user can view media albums, respond to invitations to events and by which an affinity indicator may be created and displayed;

FIG. 4 is a representative user interface displaying information concerning the location of events within a selected geographic area involving members of the user's social network community and presented on a map display;

FIG. 4A is a representative user interface showing the user's community events shown in FIG. 4, but displayed in a scrollable list form;

FIG. 5 is a representative user interface listing the user's community events in scrollable format and displaying controls enabling the user to respond to an invitation;

FIG. 5A is a representative user interface similar to that of FIG. 5 but in which the invitation response control enables the invitee to extend secondary invitations to the event to a limited or unlimited number of the invitee's friends;

FIG. 6 is a flow chart of the operation of the system by which events are created, invitations extended, acceptances sent and received and guest lists are created;

FIG. 7 is a representative graphic user interface from which a user can create an event;

FIG. 8 is a representative graphic user interface of an invitation list from which a host may select invitees from among his friends;

FIG. 9 is a representative graphic user interface by which the host of an event can select the degree of privacy for the event;

FIG. 10 is a representative graphic user interface of a guest list for an event;

FIG. 11 is a flowchart illustrating operation of the media sharing module of the system by which a user may capture and upload media from an event and by which the media can be shared and/or viewed and commented on with members of his community;

FIG. 12 is a representative user interface displayed on attendee's devices at an event in which they may view media captured at the event and including controls to capture media and automatically send it to the server; and

FIG. 13 is another representative user interface enabling a user to view a selected media image from an event together with comments posted with respect to that media from the event and allowing the user to post his own comments.

### DETAILED DESCRIPTION

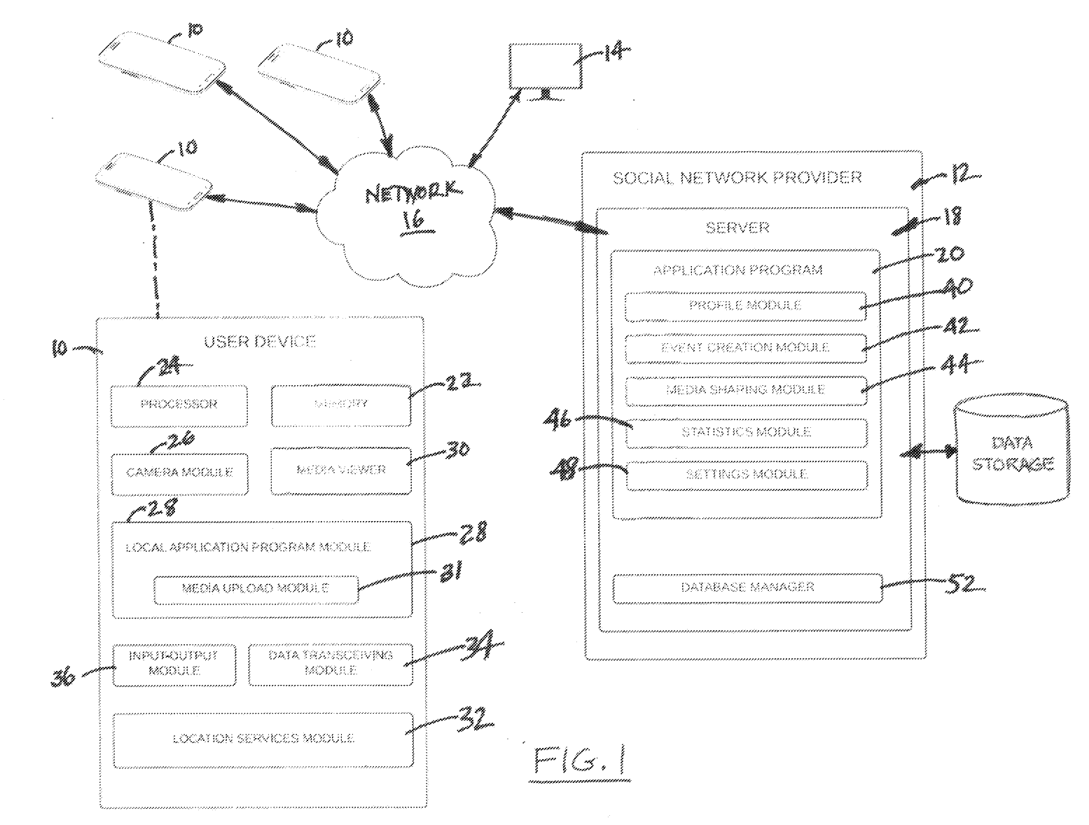

FIG. 1 illustrates, diagrammatically, a representative system environment in which the social networking system of the invention may be employed. The system operates with mobile user devices 10 such as, for example, cell phones, smart phones, personal digital assistants, and other mobile computing and communication devices that have the ability to communicate via networking systems with server computers or database server systems and also have the ability to capture, communicate and display visual and audiovisual media. The user devices 10 may include software, firmware and/or hardware components to facilitate functionality of the system and may include portions of an application program, such as portions of a media-sharing module of the application program to be executed by processors of the user device in conjunction with other portions of the application program that reside in one or more remote servers (the “server 18”) associated with a social network provider. Communication links may be via the Internet, satellite or land-based antennae systems. The user devices include a display for presenting information and user interfaces that include control elements by which the user can navigate and implement various aspects of the system. The display may include a touchscreen on which graphic input controls may be presented in user interfaces, although other input user devices may include alphanumeric or other keys or mechanical elements to input commands or data. The user devices include communication electronics and/or software and may be any of a variety of mobile devices. Less mobile devices such as desktop computers 14 also may access and use certain aspects of the system but with limited functionality in that they are unable to capture photographic images at remote events.

The user devices 10, 14 communicate over a network 16 (e.g., the Internet) with a server computer 18 associated with a service provider 20. The server 18 includes a web networking application program 20 including a media-sharing module 44 that enables a user device 10 to connect to the server and to access and upload media content and other information. Users may access and use the system via network communication links to the server or through a website maintained by the social network provider. The server 18 may be a web server, an Applications Programming Interface (API) server or another type of server capable of performing the various operations described.

The user device should include a local memory 22, a processor 24, image capture system 26 (a camera), a local application program module 28 adapted to execute commands, instructions or initiate functions in cooperation with the server 18 based on input and control signals from the user device, a media viewer 30, a media upload module 31, a location services module 32, a data transmission module 34 for transmitting data and receiving data from the server and an input-output system 36 that may comprise, for example, a touchscreen. The location services module 32 generates information as to the location of the user device and may function to receive and transmit signals in a variety of ways, for example, a global positioning system (GPS), a Wi-Fi positioning system and/or cell-site triangulations.

The server 18 executes the social network application program 20 and includes program modules that may be self-executing or executed in response to commands received from a user device via the network 16. The modules may include a profile module 40, an event-creation module 42, a media-sharing module 44, a statistics module 46 and a settings module 48. The server 18 is coupled to a digital memory storage system 50 that includes one or more databases by which various types of data used by the server, such as user profiles, media content, event-related data, location services and map data and other content can be stored and from which it can be retrieved and processed by a database management system 52 controlled by the server in response to commands and queries from user devices. The database management system 52 can be merged with the server 18 or may be embodied in a separate database server 54 having sufficient data storage capacity to store the data and to perform the functions of the social networking system.

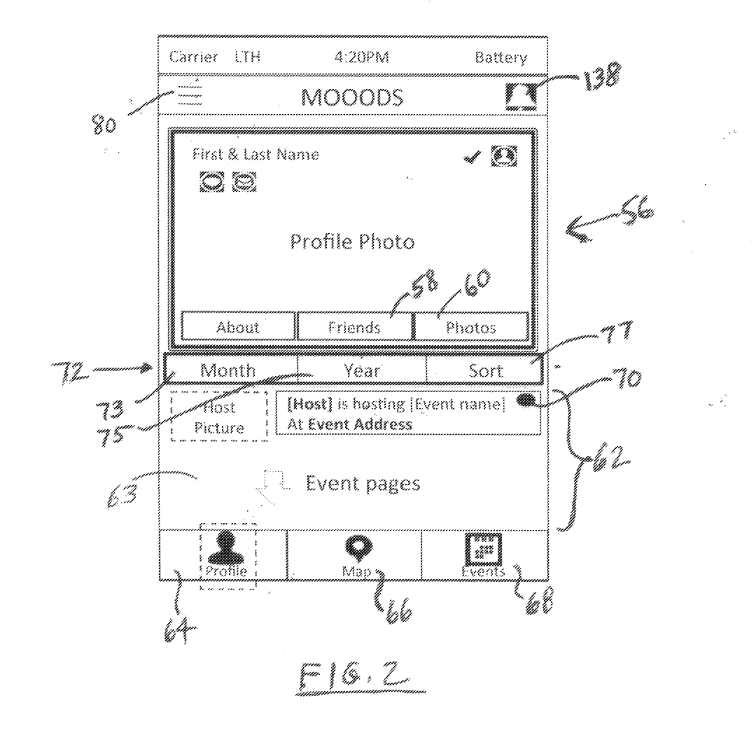

Upon launching the software application from a user device 10, 14, as by invoking an application icon on the user device, the user device displays a login UI (not shown) on its display screen. If the user is not yet a registered member of the social network, the login screen enables him to invoke one or more registration screens (not shown) where the user's profile and other information necessary or desirable to become a registered user of the social network can be entered. That information is transmitted to the server and is stored in the database. When the registered user logs in, the device communicates with the server 18 via the communications network 16 and the server 18 responds by transmitting a signal causing display of a default/profile UI 56 (FIG. 2) stored in the local memory 22 of the user device. It should be understood that the default/profile UI 56 and all user interfaces described herein, are intended merely as diagrammatic, illustrative examples and that UIs may be configured in any arrangement or manner to facilitate use and operation of the system.

The default UI 56 may include the user's name and profile photo. It may include navigation control buttons 58, 60 enabling the user to communicate with the server to access profile information relating to other members of the user's social network community (his friends) or to view selected media albums of past events involving the user and his friends that have been stored in the database and to which the user has the right to access. Activating the “friends” control 58 signals the server to retrieve and display to the user a list of the user's friends and the user may select a friend from the list to cause the server to send that friend's profile information to the user. Activating the “photos” control 60 signals the server to retrieve and present a list of albums from prior events that the user has the right to access and the user can select an album from the list to request the server to transmit the album to the user's device.

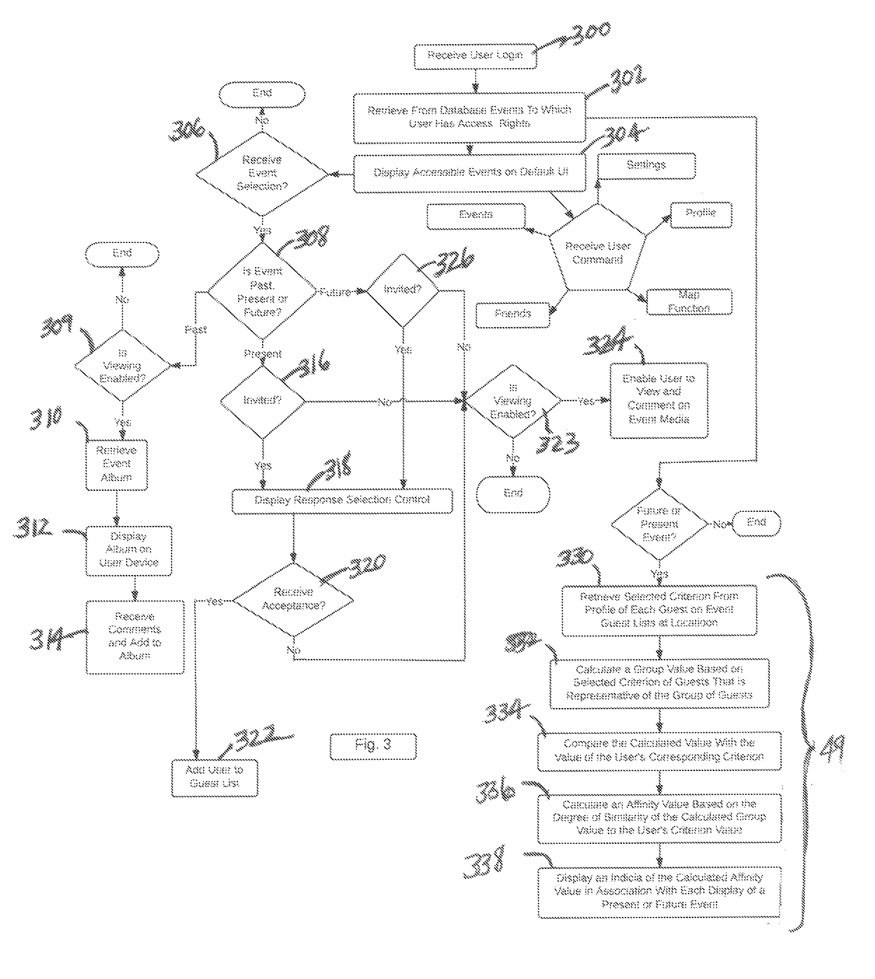

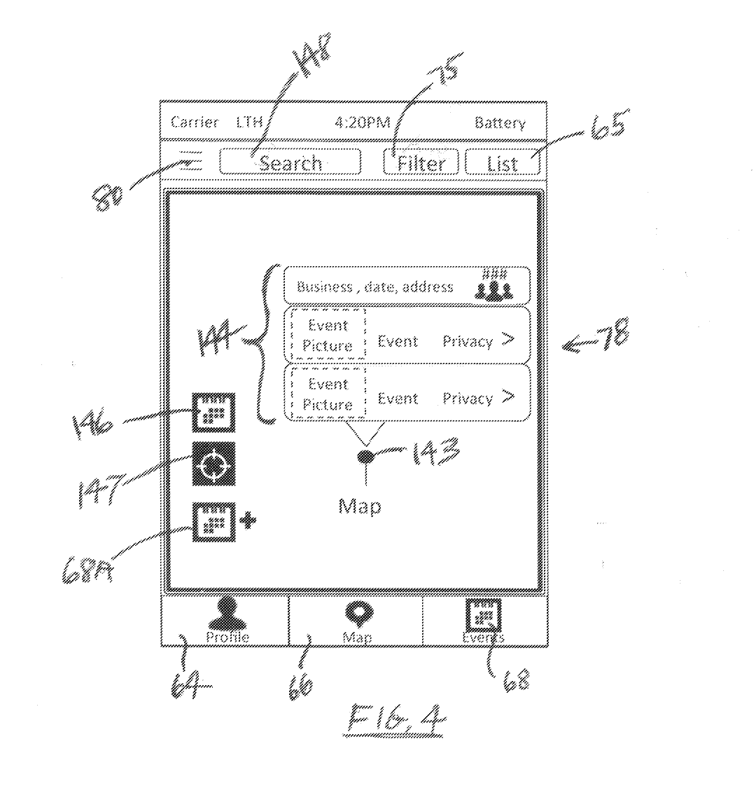

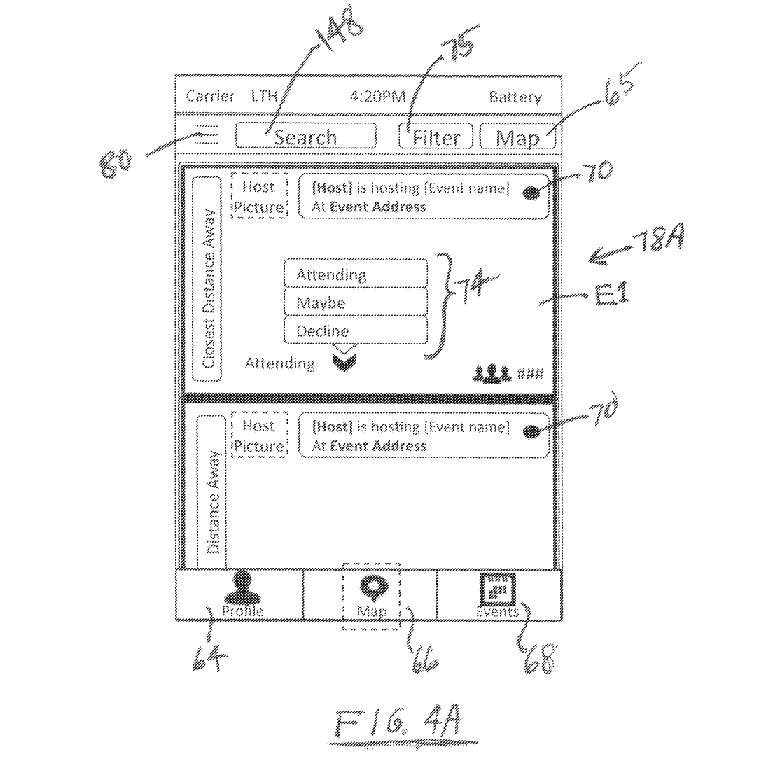

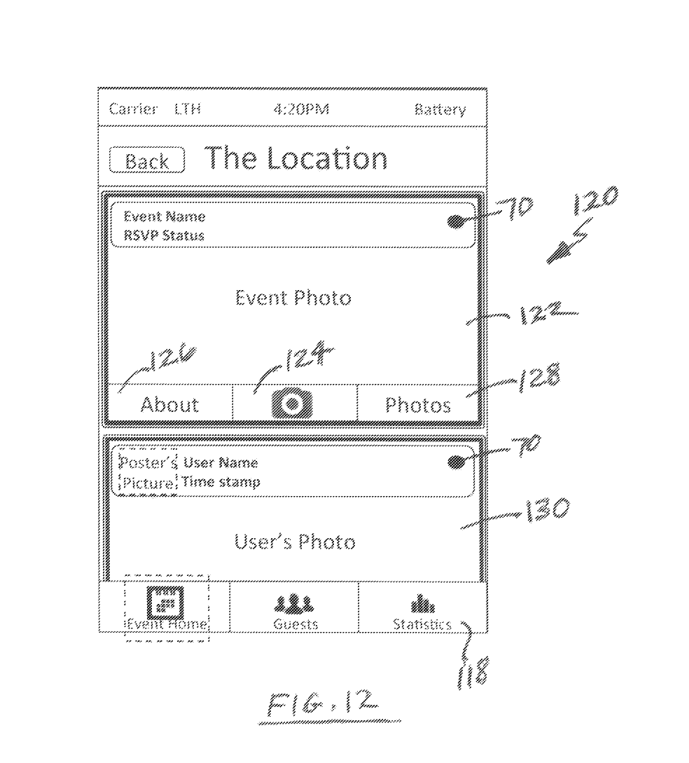

FIG. 3 is a flow diagram illustrating operation of the system as may occur by control from the default UI 56. Upon receiving the login signal from the user device (step 300), the application program retrieves from the database information relating to past, present and future events involving members of the users social network community (step 302). Information relating to the past and present retrieved events is displayed to the user, for example, on an event display region 62 of the default UI 56 (step 304). The information displayed on the UI 56 concerning the events may include identification of the host, the venue, time and date and may include an image selected by the host, such as an image of the venue or an image iconic of the type or subject of the event. The display within region 62 may be associated with a scrolling function. Each listed event 63 also can serve as a control button that can be activated (as by touch on a touchscreen) to navigate to another user interface, such as the location event UI 120 (FIG. 12) where the album for that event to which the user has a right to access is displayed. The default UI 56, as well as a number of other user interfaces, may include additional navigation controls 64, 66, 68 to enable the user to display the default/profile UI 56, location identification (GPS map) UI 78 (FIG. 4), or an event management UI 76 (FIG. 5), respectively. A user can toggle between the map display of events (FIG. 4) and the list display of those events (FIG. 4A) by invoking a toggle control 65 on each of the UIs 78, 78A. The default UI 56, as well as some of the other UIs also preferably includes controls enabling the user to invoke the event creation module 42 (control 68A), the profile module 40 (control 64), the settings module 46 (control 80), as well as information concerning members of the users social network community (control 58).

In one aspect of the invention, the UIs that display information concerning current and future events also may include an affinity indicator 70 that displays the output of an affinity module 49 (described below) that may be part of a statistics module 46 by which the demographic and user profile information for those on the guest list for an event is processed by the server to determine whether and to what degree the user's interests or other characteristics match up with those users who plan to attend or are in attendance at an ongoing event. Affinity indicator 70 may take any of a number of forms, for example, a geometric figure the color of which can be changed to correspond to the degree of affinity or a numerical value or the like. For example, green could indicate a strong affinity; yellow-orange a neutral affinity and red, a low affinity. The affinity indicator may be displayed as a graduated spectrum of colors or with other indicia such as alphanumeric or other suitable display. The affinity indicator may be displayed in association with any identification of an event or event location.

The default UI 56 also may include month and year controls 73, 75 to request the server to search the database and display on the user's device, albums from events within the requested time frame. The controls 73, 75 may cause display of date reels (not shown) from which the user can make selections. A number of navigation controls also may be provided on the default UI to navigate to other UIs. In the illustrative embodiment shown in FIG. 2 the navigation controls may include a settings control 80 by which the user can access his settings to edit his profile picture, select a level of privacy, edit details of his account with the social network service provider 18, log out, etc.

As illustrated in the flow chart of FIG. 3, if the user elects to view any of the events populated on the display region 62 of the default UI 56, as by invoking the control function of a displayed event, the application, upon receiving the event selection (step 306), determines whether the event is a past event, a present event or a future event (step 308). If a past event, the application determines whether viewing of albums is enabled (step 309), as described below. If it is enabled, the application causes the media that comprises the selected album from that event to be retrieved from the database and transmitted to the user device for display, with the media in chronological order, on the user's device (steps 310, 312). The user may view the media and comments that others may have posted to the album with respect to that media. The user also may upload his own comments to the media and his comments will become part of the viewable album (step 314).

If the event is a present event the program determines whether the user has been invited to the event (described below) (step 316). If the user has been invited to the event the application causes a response selection control 74 to be displayed to the user in association with each such event (step 318). The response selection control 74 may, for example, be displayed on an event listing UI 76 (FIG. 5) that lists all of the events to which the user has a right to access. The response selection control 74 also may be displayed in association with a list of events to which the user has been invited or otherwise has access rights and were indicated on the map UI 78 (FIG. 4A). The selection control 74 enables the user to indicate that he will attend, that he is uncertain or that he declines. When the server receives an invitee's acceptance (step 320), the user is added to a guest list (step 322).

If an invitee has declined or has failed to respond he still may be able to view and comment on the event media during and after the time of the event (step 324) if, when the event was created, the host enabled non-attendees to view the event albums, as described below.

If the event is a future event the application determines whether the user has been invited (step 326). If he has been invited the response selection control 74 is displayed (step 318) and the user is prompted to respond, as above. If the user has not been invited he will be able to view and comment on the event media during and after the time of the event (step 324) but only if the host has enabled friends of attendees to access the event albums.

The affinity module 49 is illustrated in FIG. 3 and functions to determine and display to the user the degree of affinity of a particular group of guests for an event with the user. As discussed in more detail below, the affinity module generates an affinity indication and displays it in association with each display of present and future of the user's community events.

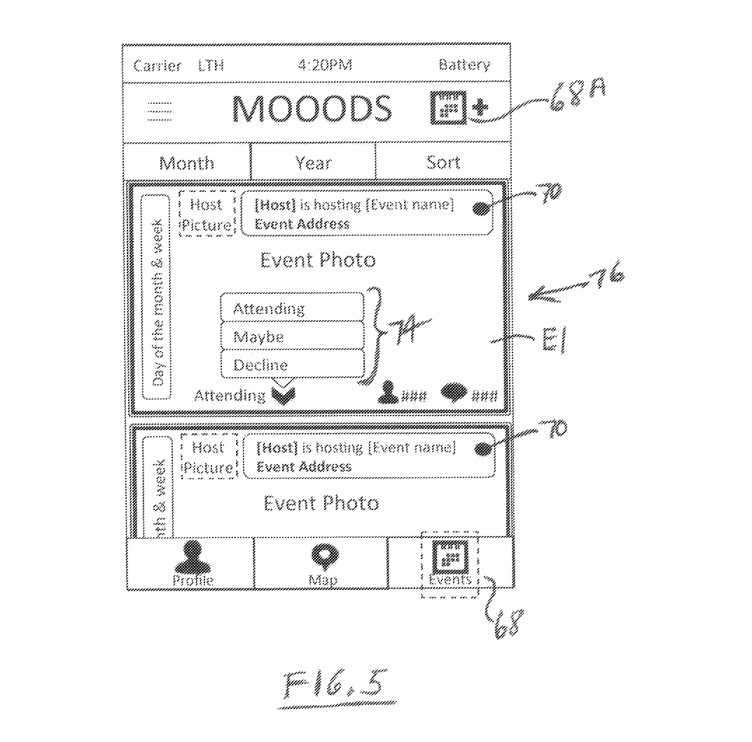

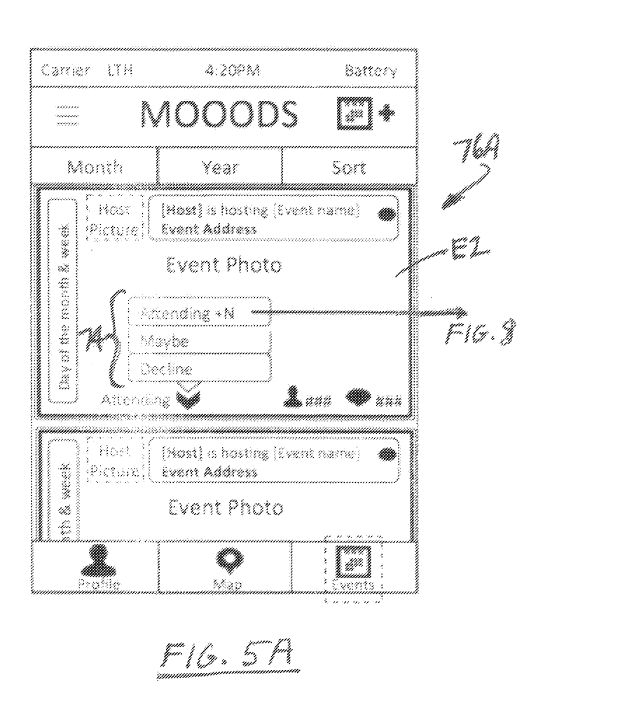

The flowchart of FIG. 6 illustrates operation of the event creation module 42. Any member of the social network community may create an event by actuating the event control 68A on one or more UIs (see FIGS. 4 and 5 which can be accessed from the default UI 56 by actuating controls 66, 68, respectively). Actuating the control 68A causes display of a create-event UI 82 (FIG. 7). The create-event UI 82 may include input regions, such as indicated at 84, 86, 88, 90, 92, 94 and 96 to enter the name of the event (e.g., Joe's 50th), the location (e.g., Westin Hotel, Boston), the name of the host (e.g., Brad Smith), type of event (e.g., Birthday party), the viewing access, an expanded description of the events and a photo or other graphic media, respectively. The viewing access control 92 enables the user to control the extent to which albums created at the event may be viewed. By default, all attendees at the event have access to view and comment on media created at the event. Whether non-attendees will have viewing and commenting access depends on the selection made by control 92. Invoking control 92 may, for example, toggle between “attendees” and “community,” the latter enabling viewing by non-attending members of the host's community as well those in attendance while the former restricts viewing to attendees only.

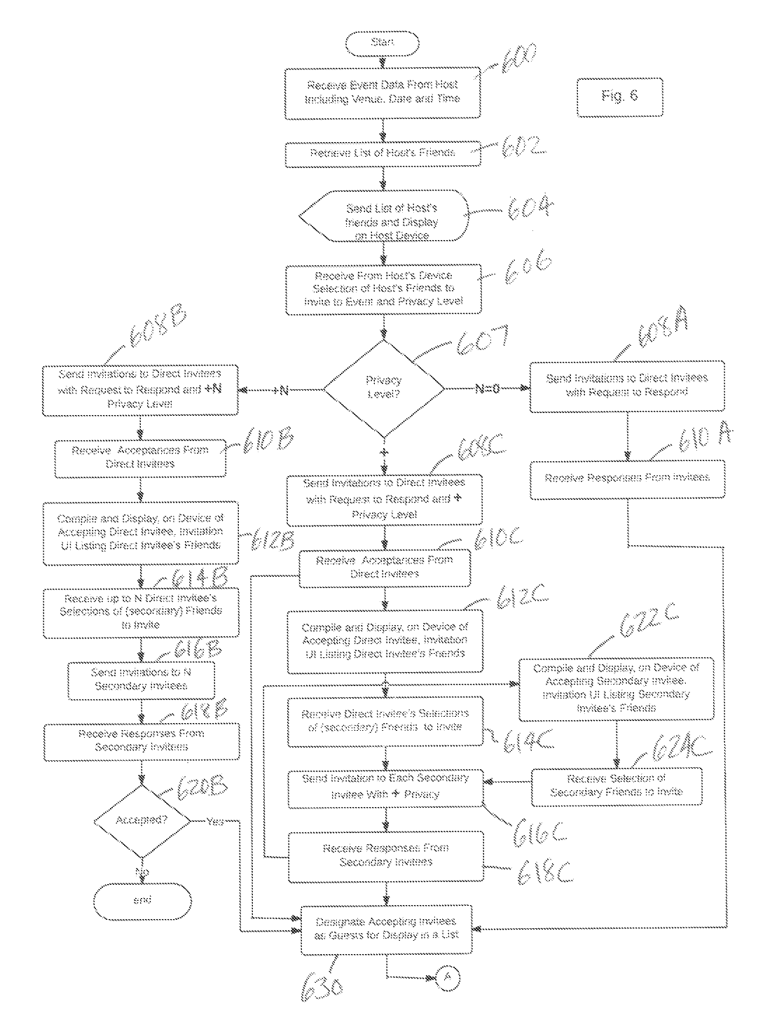

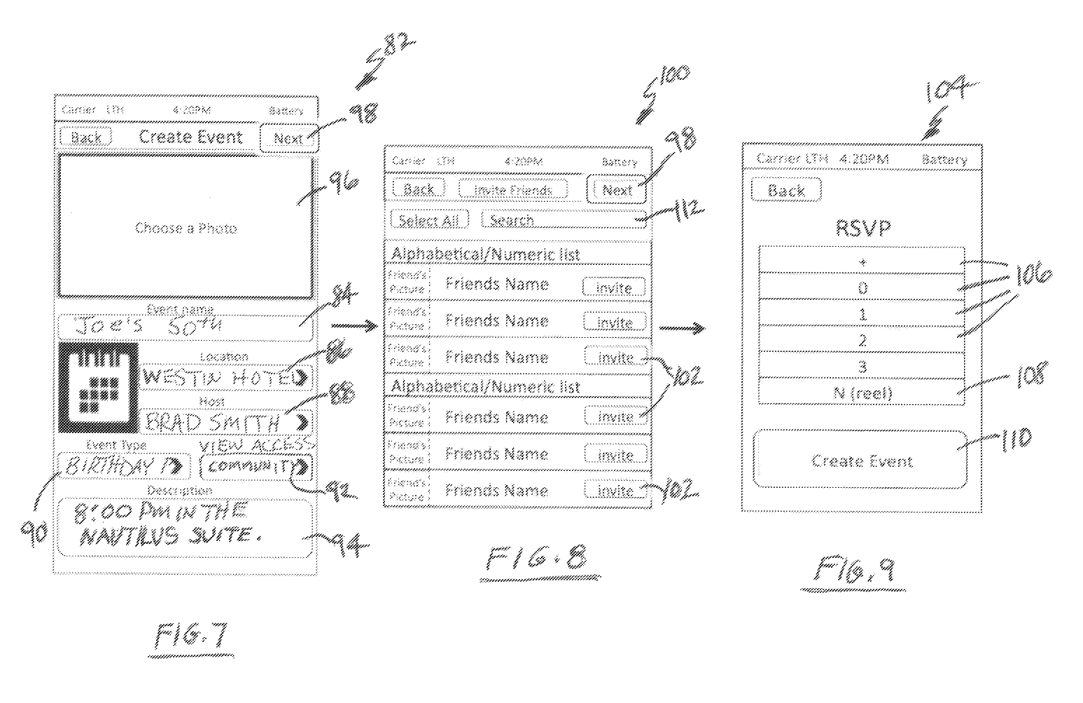

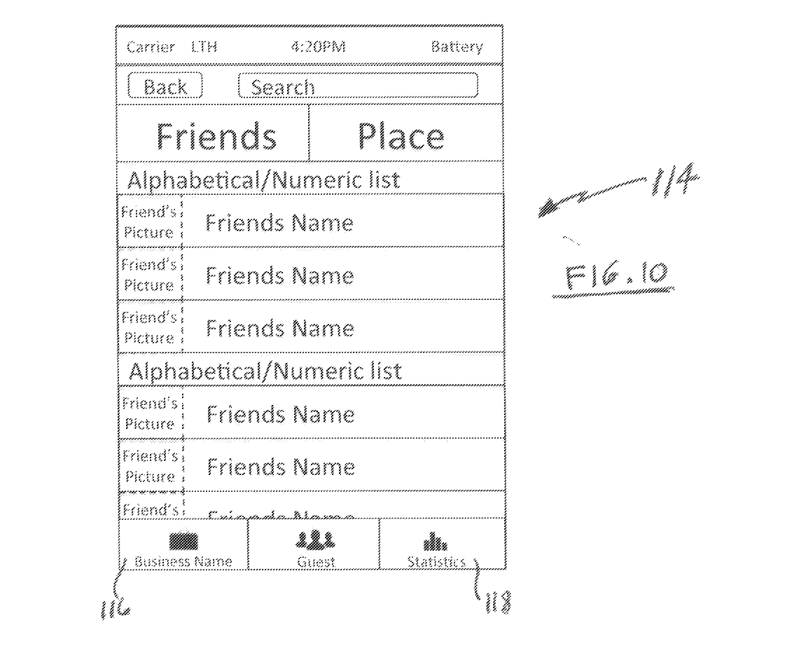

When entry of all of the event creation information has been completed, the user invokes a “next” control 98 that causes the server to retrieve a list of the host's friends and to display that list in an invitation UI 100 on the host's device together with invitation controls 102 associated with each of the host's listed friends, as shown in the example of FIG. 8 (step 604). The host then may select those of his friends that he wishes to invite. The host then selects the “next” control to advance to an invitee privacy level UI 104 (e.g., FIG. 9) where the host can select a desired level of privacy. In the illustrative example of FIG. 9 the host may select from among controls 106 indicating the number of secondary invitees, if any, that the direct invitees may invite. For example, in the illustrated exemplary UI 104 the host may select the “0” control 106 (no secondary invitees) to limit the attendees only to direct invitees. Alternately he may select the “2” control 106 to indicate that his direct invitees will be able to extend “secondary” invitations to two of their friends on the social network. One of the controls may include a “no privacy” level (e.g., a “+” symbol) to indicate that no limit is placed on the number of secondary invitations that a direct invitee may make. The “no privacy” level also may enable the secondary invitees to extend invitations to their friends, etc., creating what may be considered as an unlimited event for the social network community. One of the controls may include a pop-up reel 108 that, when invoked, causes a scrollable list of numbers greater than those in the fixed of the controls 106 to appear. All of the information inputted in the event creation process is stored in the local memory of the user device until the host invokes a “create-event” control 110 on the user interface 104 of FIG. 9. Invoking the create-event control 110 causes transmission of the invitee and privacy level information to be transmitted to the server 18 (step 606).

Upon receipt of the invitee list and privacy level data, the application causes the server to determine the privacy level chosen by the host for the event (step 607). Assuming, for illustration, that attendance at the event is to be limited only to the host's selected friends (e.g., N=0). The server 18 then sends invitations to those direct invitees selected by the host (step 608A). The invitations appear as response selection controls 74 on one or several UIs including UI 76, 76A or 78A. Additionally, the user may be notified that he has received an invitation, or other message, by the appearance of a message icon 138 on the default UI 56. Upon receiving responses from the invitees (step 610A), the application program designates those who have accepted the invitation guests that may be displayed as a guest list (step 630).

For an event in which the host has elected to have open invitations (i.e., any invitee may invite any number of their friends), the application recognizes the event as being open to any member of the social network community and begins by retrieving a list of the host's friends (step 602) and sending that list to be displayed on the host's user device (step 604). The host selects those friends that he wishes to invite. Upon receipt from the host's user device of the selection of friends he wishes to invite (step 606) the application causes invitations to be sent to the direct invitees together with a request to respond and an indication of the privacy level (+) indicating that the invitee may invite as many of his friends as he wishes (step 608C). Upon receipt by the server of the acceptances of the direct invitees (step 610C) those invitees are added to the guest list (step 630). Additionally, upon acceptance from the direct invitees, the event creation module 42 compiles a list of the direct invitee's friends and causes that list to be displayed on the friends list UI 100 of the direct invitee's user device (step 612C). The direct invitee then may select those of his friends whom he wishes to invite (secondary invitees) and transmits those selections to the server (step 614C). The server then executes the application to send invitations to each of the selected secondary invitees together with an indication (“+”) that they, in turn, may invite an unlimited number of their friends to the event (step 616C). Upon receipt by the server 18 of responses from secondary invitees, those secondary invitees are added to the guest list (step 630). Additionally, the server compiles and displays on the user devices of the accepting secondary invitees an invitation UI 100 (FIG. 8) displaying the secondary invitees' friends (step 622C). The secondary invitees then select those of their friends whom they wish to invite to the event and transmit that list to the server 18. Upon receipt by the server (step 624C) the application program causes invitations to be sent to each of the secondary invitees' selected friends (step 616C). Upon receipt of responses from the secondary invitees' friends (step 618C), those who accepted the invitation are added to the guest list (step 630) and the server compiles and displays on the accepting secondary invitees user devices a list of their friends (622C). The addition of accepting secondary invitees to the guest list, and the steps 622C, 624C, 616C, 618C are repeated in an endless loop until no more invitees accept invitations to the event.

In a case where a host desires to limit the number of friends that a direct invitee may invite, he first transmits event data to the server where the server retrieves and sends a list of the host's friends to the host's user device (steps 600, 602, 604). The host selects those of his friends that he wishes to invite together with the limit on the number of permitted secondary invitees from privacy UI 104 (step 606). For example, if the host has selected a control 106 to allow his invitees to invite up to two of their friends (N=2), that will be transmitted to the server where the privacy level will be determined by the application at step 607. The application then causes the server to send invitations to the direct invitees together with an indication that they are allowed to invite up to two of their friends (step 608B). Upon receipt by the server of acceptances from the direct invitees (step 610 B), the application causes the server to compile and display on the devices of the accepting direct invitees, invitation UIs 100 from which the direct invitees may select friends to invite to the event, but only up to the pre-designated limit (step 612B). Upon receipt by the server of the selected secondary invitees (step 614B), the server sends invitations to the selected secondary invitees (step 616B). Upon receiving responses from the secondary invitees (step 618B), those who have accepted are added to the guest list (step 630). When a direct invitee's allotted secondary invitees have accepted, the direct invitee's invitation list is disabled so that he cannot invite more secondary invitees. If an invitation to a secondary invitee is not accepted, the direct invitee can rescind the invitation and then will be allowed to send another secondary invitation until the accepted invitations reach the allotted number.

An invitee may receive notice of an invitation on his user device when he logs in to the network and accesses his events UI 76 (FIG. 5) where the response prompt 74 is displayed in association with the event. The response prompt 74 also may be displayed on the list of events (FIG. 4A) corresponding to the venues identified on the map UI 78 (FIG. 4). The user may select one of the controls to indicate that he plans to attend, that he may attend but is uncertain or to decline.

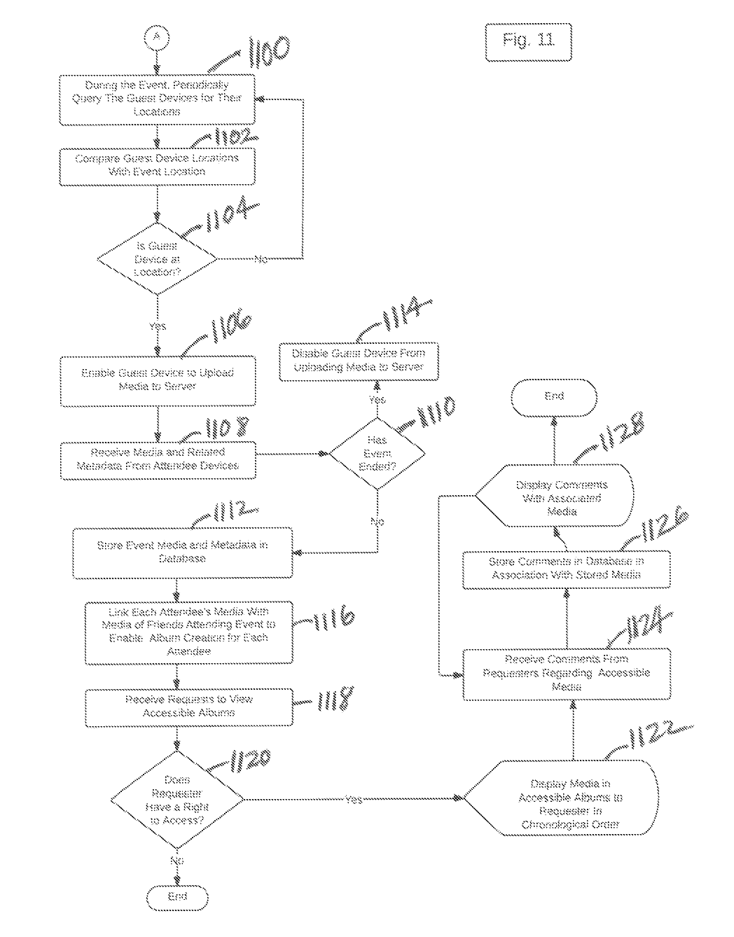

While the photographic system of the user device may be able to take pictures or videos at any time, the media-sharing module 31 enables the camera shutter to be controlled by the application and enables uploading of photos or videos to the server 18 only during the scheduled time for the event and only when it has been confirmed that the guest is actually at the location of the event and is an attendee. The flowchart of FIG. 11 illustrates operation of the media-sharing module 44 of the system. At the time scheduled for the event, the application causes the server to periodically query the user devices of the invitees on the guest list to invoke their location identification modules and report to the server their respective locations (step 1100). The server 18 then compares the reported locations with the event location stored in the database (step 1102) and if it is determined (step 1104) that the guest has “checked-in” (i.e., that he is at the location of the event or within a predefined radius from the location), the media upload module 31 of the user device 10 is enabled to permit operation of the full media-sharing module (step 1106) by a signal from the server. As the media upload module is enabled, the user device is caused to display a location UI 120 for use by the attendees at the event (FIG. 12). The location UI 120 includes a photo control 124 that operates to control the camera system of the user device to capture an image or video. The user device is provided with an application program interface (API) that may be obtained from the user device manufacturer that enables the camera operation to be controlled by the application program whether in still or video mode. Once enabled, media captured by the attendee's device is automatically transmitted to the server 18. As long as the event is ongoing (step 1110) the media is stored in the database (step 1112) and is linked, by reference to the metadata associated with the media, to those of the user's friends who are recognized as present at the event (step 1116). At the scheduled conclusion of the event the media-sharing module disables the media upload portion of the media-sharing module to terminate the ability of the user devices to upload media to the server (step 1114) and terminates camera control by the application program. In a preferred default mode every attendee shares the media that he created during the event with each of his friends in attendance at the event. Shared media can be downloaded as well as viewed. Each attendee's media (media that his device uploaded at the event) and media uploaded by that attendee's friends at the event becomes part of that attendee's album. The portion of the media-sharing module that enables attendees and friends of attendees to post commentary, however, is not disabled and viewing and the ability to comment continues indefinitely. Each attendee's album can be viewed and commented on by friends of that attendee provided that the event was created with that accessibility.

If a user on the guest list fails to attend, the media upload module 31 of his user device remains in its normally disabled state and cannot upload media to the server. A non-attending guest as well as other non-attending friends of an attendee, may, however, still have the ability to view and comment on media and comments that have been uploaded to the server by others, depending on whether the host, when creating the event, enabled access to the members of an attendee's community (FIG. 7).

An invitee who has declined an invitation but wants to view media from an event remotely may request access to that media. Upon receiving that request (step 1118), the application program determines if the user has friends checked-in to the event. If not, the user cannot access any of the event media that may have been uploaded to the server, either to view or comment. After a friend of the user has been checked-in to the event, the remote user (i.e., not at the event) will be considered to have a right to access (step 1120) and will be able to view and comment on the media and comments in that friend's album during and after the event. The remote user's device will display the event (for example on the user's default UI 56) and will enable the user, by selecting the event, to access photos, videos and comments posted during and after the event. The remotely located user also may post comments and may view comments posted by others.

The remote user with a right to access will be able to view his attending friend's album, including media posted by attending friends of the attendee's friend, even if the remote user is not a friend of the attendee's friend. Upon receiving a request by a user with a right to access, to view an album, the application causes the server to transmit for display on the requester's device, the album requested by presenting the media in chronological order (step 1122). The requester can toggle to the UI 132 to view posted comments for that media and can post comments of his own. The server receives the comments (step 1124) and stores them in the database in association with the particular media item to which the comment pertains (step 1126). Subsequent requests to view that media item will include the newly added comment that will be displayed to the subsequent requester (step 1128) who, in turn, may post further comments.

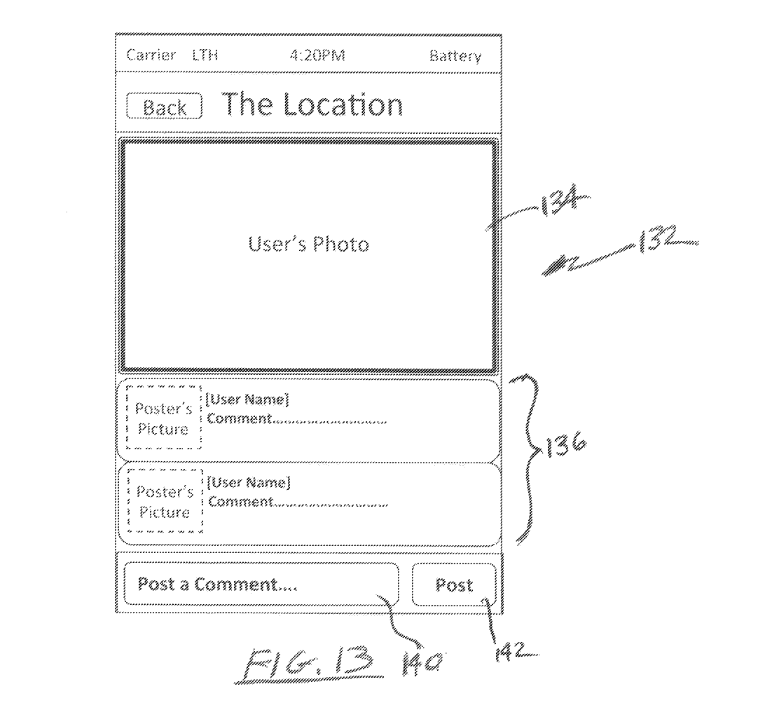

When viewing media from an event, that media also may be displayed in the location UI 120 (FIG. 12). Each displayed media item (e.g., photo 130) also may function as a control that, when invoked, causes display of another album UI 132 (FIG. 13) that displays the selected photo together with a comment panel 136 in which previously uploaded comments associated with the displayed photo are presented. The album UI 132 also includes dialog panel 140 where the user can input comments. The comment then can be posted by invoking a “post” control 142. The posted comment then will be added to and displayed in the comment panel 136.

The system also includes mapping functions by which the locations of events involving the user's social network community for any given date may be identified and displayed. Data for the locations accessible by the location services module is stored in the database. The map UI 78 (FIG. 4) can be accessed by the control 66 (e.g. map icon) that is present in a number of the other UIs of the application, including the default UI 56. The map UI 78, which is a function of the location services module 32, displays a map of a geographic region and the application program 20, in conjunction with a third-party API for the location services module, determines locations of events involving the user's community and the user device transmits that information to the user device for display on the mapIn the absence of a request to display a different geographic location, the default area defined by the map UI 78 is based on the current location of the user's device and the information displayed relates to the current day. One or more pins 143 may represent locations where events involving the user's social network community are currently ongoing or are scheduled for the current day. The pins may be distinguishable from each other to reflect the affinity determination for each of the venues. Each of the pins also can serve as a control to trigger a request to the server display a list of the individual events scheduled at the venue. The user can tap any of the location pins on the map to query the server to send and display a list of the events at that location to be displayed on the user's device, as at 144 in FIG. 4. An event from the list may be selected to display its details together with the response selection control 74 (FIG. 4A) if the user has been invited to the event.

The application enables a user to identify events and locations for dates other than the default current date. To that end the map UI 78 includes a calendar control 146 that may be invoked to present a calendar display from which the user can select a future date. Upon receiving that selection the server retrieves from the database the locations of events involving the user's social network community scheduled for the selected date and transmits that information to the user device where the locations are displayed, as with pins, on the map UI 78.

The application program in the server includes a search function, by which a user can search for event locations in geographic areas other than the default area. In the map UI 78, the user can select a date using the calendar control 146 and can enter a desired geographic area in a search dialog box 148 to invoke the search function and cause the server to initiate a search for the requested events in that geographic area to which the user has a right to access. Data regarding geographic locations and venues within that area may be obtained from the location services provider (e.g., Google maps, MapQuest, etc.) and retrievably stored in the database 50. The server executes the search and transmits the search results to the user's device where the locations of the events are displayed, as by pins 143, on the map UI 78 or in list form, as on UI 78A (FIG. 4A). This aspect of the invention may be useful for a user who is travelling or is planning a trip that will include locations where he might have existing friends. It enables a user to create an event at a remote location or to search for any events scheduled in remote locations and in which any of his friends are on the guest list and, if so, to access pictures, video and text. The user may be able to contact his friend to determine if the user can attend, for example, if his friend is the host and can extend a direct invitation or if his friend has been invited and has the right to extend secondary invitations. If the user is viewing a remote location on the map UI 78, he may display his current geographic area by invoking a user-location control 147.

The map UI 78 also may be used to help select a venue when a user wants to create an event. To that end, the search function may be used to find venues at a desired geographic area by inputting a search request in the search dialog box 148 (e.g., “Boston sports bars,” “New York hotels,” etc.). That initiates a search in the database 50 and the result is transmitted to the user's device where it may be displayed in the map UI 78, as with markers such as pins 143 or in list form. The user then may use the information derived from the search to select the location of the event to be created. This may be accomplished by invoking a selected pin 143. That selection causes the create event control 68A to appear on the UI 78. The user then may invoke the create event control 68A to access the create event UI 82 to complete the event creation process. A search also may be inputted from the search input 148 of UI 78A. In that case the search result is populated on the map UI 78.

In another aspect of the invention the application may include a statistics module 46 that includes an affinity module 49 (FIG. 3) by which the profile information of the user may be compared with profile information of other users who are on the guest list for an event at that location. The affinity module 49 generates and displays on the user interfaces that display a current or future event, an affinity indicator 70 that reflects the degree of affinity (commonality of interests or demographic characteristics or other parameters) of the user to those persons on the guest lists at a location where a particular event is or will be held, thus facilitating the user's decision as to his interest in that event. This may be illustrated in a simplified example in which the criterion for determining degree of affinity is the age of those on the guest list. For each event displayed to the user, the affinity module 49 determines, by retrieving from the database, age data from the profiles of the users on the guest lists for the events at the venues of the user's community events (step 330). The affinity module employs an algorithm that automatically performs calculations to obtain a group value, that is representative of the age group of all of the guests for each event (step 332). That group value then is compared to the corresponding criterion of the user, in this example, his age (step 334). An affinity value then is determined to reflect the degree of similarity between the group value based on the selected criterion and the corresponding criterion of the user. In this example, the algorithm may simply consider the average group age as an affinity value, and then determine the relative proximity of that value to the age of the user (step 336). The result may be displayed in a manner that reflects that proximity. Thus, for example, the algorithm may calculate a numerical value (e.g., in the form of a percentage) based on the difference between the user's age and the average age of guests for a particular event. If it is assumed, for purposes of this example, that the degree of affinity may be based on a scale of 1-10 years age difference in which no difference may be considered as 100% correlation and a difference of ten years may be considered as a zero percent correlation, a difference of two years between that of the user and the average age of those on the guest list(s) at the location would correspond to a correlation of 80%.

The degree of affinity may be displayed (step 338) in association with the particular event as a percentage or in some other form, such as a numerical scale (e.g., 1-10) or in a color code in which a spectrum of colors may represent the range of differences between the user's age and the average age of the guests for a particular event. Thus, the degree of affinity may be represented by one of a progressive spectrum of colors between, for example, green (high correlation with the user's age) and red (low correlation with the user's age). The color may be applied to the affinity indicators 70 and also to the pins 143 on the map UI 78. It should be understood that the foregoing example is merely illustrative and that other criteria for determining the degree of affinity of an event for a particular user may be selected from any of the information in the profile data of the users of the social networking system, the criterion of age discussed above being only for purposes of illustration. It may be desirable in some instances, depending on the nature and detail of user profile information stored in the database, to select multiple criteria for determining affinity and it should be understood that various algorithms may be employed with more complex structure to accommodate additional criteria as the basis for analysis. Additionally it should be understood that the statistics module 49 may be configured to execute a wide variety of algorithms based on data stored in the database to represent the nature and characteristics of events.

The application may enable a user to select the criterion to be applied when determining the degree of affinity in connection with a search for events. To that end the application program provides a filter control 75 (see UIs 78, 78A, FIGS. 4, 4A) by which the user may select a criterion to be used for determining affinity. The criteria may be selected from the type of information included in the profiles of users of the social network community (e.g., age, gender, education level, relationship status, etc.) as well as information related to events (e.g., event type, location, guests, etc.). Selection of a criterion limits the search to find only those events to which the user has a right to access and satisfy the search criteria. The available criteria may be provided in a drop-down menu (not shown) that is displayed upon invocation of the filter control and from which the user may select the criteria desired.

From the foregoing, it will be appreciated that the invention provides an event based social networking system that facilitates the ability of its members to create and schedule events, extend and respond to invitations, search for events involving members of their social network communities, create audiovisual media at events that can be shared and/or viewed with other members of their social network communities, communicate with their friends by posting comments on the social network system with respect to memorable events and create lasting memories. It should be understood, however, that the foregoing description of the invention is intended merely to be illustrative thereof and that other embodiments, modifications and equivalents may be apparent to those skilled in the art without departing from the principles of the invention.

Having thus described the invention, we desire to claim:

1. A computer-implemented method for creating and enabling access, on a social networking system, to media relating to and created by attendees at an event with mobile computing and communication user devices, the computer-implemented method comprising performing computer-implemented operations for:
receiving, from user devices of attendees at the event, media and related identification data created only at and during the event;
storing and maintaining the received media in a data storage system associated with the social network system;
the media being arrangeable into albums in which each attendee is associated with an album that includes media received from that attendee and media created at and during the event and received from user devices of members of the attendee's social network community at the event and from whom media was received and stored;
receiving a request from a member of an attendee's social network community to view an album associated with that attendee and, in response to such request, transmitting to and displaying on the requester's user device, the requested album.

2. The method as defined in claim 1 wherein the media in the displayed album is displayed in chronological sequence on the requester's user device.

3. The method as defined in claim 1 further comprising:
displaying the album media in association with input means by which a requester can create and post commentary relating to selected of the media; and
receiving the commentary and storing the commentary in the data storage system in association with the selected media;
upon receiving subsequent requests to view the selected media, transmitting to the requester, for display on the requester's user device, the selected media together with the received commentary associated with that selected media.

4. The method as defined in claim 1 further comprising:
prior to transmitting an album to a requester, determining if the requester has the right to access the album and transmitting the album only if such right is determined to exist.

5. The method as defined in claim 1 wherein the requesting member attended or is in attendance at the event and wherein the transmission of the album to the requester enables the requester to view, comment on and share the media in the album.

6. The method as defined in claim 4 wherein the requesting member is a non-attendee at the event and is permitted only to view and post comments relating to the album media, but not to share that media.

7. A computer-implemented method for creating an event for selected members of a social networking system having an associated server, and for recording media images created only at and during the event with user devices, the user devices having a camera, wireless transceiving functionality, a location services module, and an application program that includes a media upload module to control the ability of the user device to capture and transmit media to the server, comprising performing computer-implemented operations for:
receiving, at the server, from a user-host of the social network, data identifying an event including at least its time, date and location;
retrieving, from a database containing profiles of users of the social networking system, data identifying those users of the system who are members of the user-host's social network community;
transmitting to the user-host an invitation list of the members of the user-host's community;
enabling controls by which the user-host may select from the listed members those whom he wishes to directly invite to the event;
receiving from the user-host identification of selected members to be direct invitees;
transmitting to the selected direct invitees a notification of the event and enabling an invitation response control on each direct invitee's user device by which the direct invitees may respond to accept the invitation;
receiving responses from the direct invitees and storing in the database, a guest list that includes all accepting invitees;
at the time of the event, periodically querying the user devices of invitees on the guest list to invoke their location services module and report to the server their geographic locations;
upon receipt from a queried user device as to its location, comparing the reported location with the location of the event; and
enabling operation of the media upload module of the device only when the user device is at or within a predetermined distance from the event location.

8. The method of claim 7 further comprising:
at the end of the event, disabling operation of the media upload module in each attendees' user device.

9. The method of claim 7 wherein the step of receiving the selection of members to directly invite includes receiving an instruction from the user-host as to whether the direct invitees may invite, as secondary invitees, members of the direct invitees' social communities and, if so, the extent of any limit on the number of permitted secondary invitees.

10. The method of claim 9 further comprising:
upon receiving an acceptance from a direct invitee, retrieving from the database a list of the members of the direct invitee's social community and transmitting the list to the direct invitee for display;
providing an invitation selection control by which secondary invitees may be selected by the direct invitee;
receiving from the direct invitee the selection of secondary invitees to be invited up to the allowed limit;
transmitting to the secondary invitees notification of the event and enabling an invitation response control on the invitee's user device by which the invitees may respond to accept the invitation;
receiving responses from the secondary invitees and adding the accepting secondary invitees to the guest list.

11. A method for use with an event-based social network system having a server and a database, the database containing profile data for the users of the social network system, linking data associating users with members of their community on the social network, event data corresponding to present and future scheduled events and guest list data identifying guests expected to attend the events, the method comprising:
in response to a signal transmitted to the server from a device of a user of the social network, retrieving data relating to those present and future events for which at least one member of the user's social network community is on the guest list;
for each event, comparing at least one criterion of the user selected from the user's profile data with the same at least one criterion of the guests on the guest list, considered as a group;
determining the degree of similarity of the at least one criterion of the user to that of the group of guests; and
displaying to the user information identifying the event and, in association with each event, displaying an indicator corresponding to the determined degree of similarity.

12. The method as defined in claim 11 wherein the transmitted signal comprises logging in to the social network system.

13. The method as defined in claim 11 wherein the step of determining the degree of similarity comprises:
computing, for each event, a value based on the selected profile criteria of the users on the guest list for that event, that is representative of the guests considered as a group; and
comparing the computed value for the group with a corresponding value for the user; and
wherein the displayed indicator corresponds to the degree of similarity of the compared values.

14. The method as defined in claim 11 wherein the indicator comprises color.

15. The method as defined in claim 11 wherein the indicator comprises a scalable value in which the degree of similarity is represented by a value on the scale.

16. The method as defined in claim 11 wherein the information identifying the events are displayed on the user's device as markers on a map at the locations of the events, each marker being displayed in association with an indicator of the degree of similarity for that event.

17. The method as defined in claim 11 wherein the indicator is color.

18. The method as defined in claim 11 wherein a plurality of events are scheduled for overlapping times at the same location, the method further comprising:
the step of retrieving at least one criterion for each user being performed with respect to each user on each of the guest lists for the overlapping events in which a member of the user's social network community is on the guest list;
computing, a value based on the selected profile criteria of the users on the guest lists for the overlapping events at that location that is representative of the guests for that location, considered as a group;
comparing the computed value for the group with a corresponding value for the user; and
displaying to the user information identifying the location and, in association with each location, displaying an indicator corresponding to the degree of similarity of the compared values.

19. A system for creating and memorializing an event involving members of a social network community that includes media capture by members' user devices at the event and uploading the captured media to a server and database that contains profile data of the users of the social network, including data linking each user with the members of that user's community, the system comprising:
memory for storing executable instructions for implementing an event;
a processor for executing the executable instructions stored in the memory, the executable instructions further comprising:
an event-creation module adapted to receive event-identifying data from a hosting member of the community, the data including the time and location of the event, the event creation module including an invitation module adapted to enable the hosting member to invite selected members of his social network community to the event, the invitation module being configured to enable invitees to respond to the invitation and being further configured to receive accepting responses from invitees;
a media sharing module adapted to control the user devices of the accepting invitees to enable capture and uploading of media to the server by those devices only while the user device is present at the event location and during the time of the event, the media sharing module being further configured to present media created and uploaded by each attendee in an album associated with that attendee, the album of each attending member being shared by each attending member of the attending member's community.

20. The system as defined in claim 19 wherein the media-sharing module is further configured to include in each attendee's album media created and uploaded by other attending members of the attendee's social network community.

21. The system as defined in claim 20 wherein the media-sharing module is configured to enable non-attending members of the attendee's community to view that attendee's album.

22. The system as defined in claim 21 wherein the event-creation module enables the hosting user to selectively preclude non-attending members of the attendee's community from viewing attendee's albums.

22. The system as defined in claim 20 wherein the media-sharing module is further configured to display the album media in association with input means by which a viewer can create and post commentary relating to selected of the media; to receive the commentary and store the commentary in the database in association with the selected media; and upon receiving subsequent requests to view the selected media, transmit to the requester, for display on the requester's user device, the selected media together with the commentary associated with that selected media.

23. The system as defined in claim 19 wherein the user devices include a location services module and wherein the media-sharing module is configured to periodically query the user devices associated with each guest, during the time of the event, to cause the location services module to transmit location data to the server, and upon receipt of the location data, compare the transmitted location data with the location data for the event and determine the proximity of the user device to the event location; and for each guest determined to be within a defined proximity to the event, enabling the guest's device to capture images and upload the images to the server only while the device is within the defined proximity and during the event.

24. The system as defined in claim 23 wherein the media-sharing module is configured to disable the ability of the user devices to capture and upload media to the server at the conclusion of the event.

25. The system as defined in claim 19 wherein the invitation module is configured to enable the user-host to permit his directly invited community members to extend secondary invitations to the event to members of their respective communities; and to receive responses from the secondary invitees accepting the secondary invitations.

26. The system as defined in claim 25 wherein the event-creation module is configured to enable the user-host to limit the number of secondary invitations that can be extended and wherein the invitation module precludes the direct invitees from extending secondary invitations beyond that limit.

27. A system for creating events involving members of a community within a social network system and for notifying members of those events, the system comprising:
a server adapted to communicate with devices associated with users of the social networking system;
a database to the server, the database containing profile data for the users of the social network system, linking data associating users with members of their community on the social network, event data corresponding to present and future scheduled events and guest list data identifying guests expected to attend the events;
the server including memory for storing executable instructions and a processor for executing the executable instructions stored in the memory, the executable instructions comprising:
a statistics module configured to (a) retrieve from the database, in response to receipt by the server of a signal from a device of a user of the social network, data relating to those present and future events for which at least one member of the user's social network community is on the guest list; and, for each such event, (b) retrieve and compare at least one criterion of the user selected from the user's profile data with the same at least one criterion of the guests on the guest list, considered as a group; (c) to determine the degree of similarity of the at least one criterion of the user to that of the group of guests; and (d) to transmit to the user's device information identifying the event and, in association with each event, to display an indicator corresponding to the determined degree of similarity.

28. The system as defined in claim 27 wherein the transmitted signal comprises the user's logging in to the social network.

29. The system as defined in claim 27 wherein the statistics module is further configured to determine the degree of similarity by (a) computing, for each event, a value based on the selected profile criteria of the users on the guest list for that event, that is representative of the guests considered as a group; (b) comparing the computed value for the group with a corresponding value for the user; and wherein the displayed indicator corresponds to the degree of similarity of the compared values.

30. The system as defined in claim 27 wherein the statistics module is configured to display the indicator as a color selected from a group of colors.

31. The system as defined in claim 27 wherein the statistics module is configured to present the indicator as a scalable value in which the degree of similarity is represented by a value on the scale.

32. The system as defined in claim 27 wherein the user devices have a location identification module and wherein the statistics module is configured to identify the events as markers displayed on a map at the locations of the events, and where each marker is displayed in association with an indicator of the degree of similarity for that event.

33. The system as defined in claim 32 wherein the indicator is a color.

34. The system as defined in claim 27 wherein the statistics module is further configured to (a) determine whether there are a plurality of events scheduled for overlapping times at the same location and, if so, (b) retrieve at least one profile criterion for each user on each guest list of the overlapping events in which a member of the user's social community is on the guest list; (c) compute a value based on the selected profile criteria of the users on the guests lists for the overlapping events at that location that is representative of the guests for that location considered as a group; (d) compare the computed value for the group with a corresponding value for the user; and (e) display to the user information identifying the location and, in association with each location, displaying an indicator corresponding to the degree of similarity of the compared values.
